(19) United States
(12) Patent Application Publication
(10) Pub. No.: US 2013/0180744 A1
(43) Pub. Date: Jul. 18, 2013

(54) Operator Interface for an Implement Control System

(71) Applicants: Scott Favreau, Peoria, IL (US); Benjamin T. Nelson, Peoria, IL (US)

(72) Inventors: Scott Favreau, Peoria, IL (US); Benjamin T. Nelson, Peoria, IL (US)

(73) Assignee: CATERPILLAR, INC., Peoria, IL (US)

(21) Appl. No.: 13/348,800

(22) Filed: Jan. 12, 2012

(51) Int. Cl. E02F 3/84; G05D 1/02; E02F 3/76; G06F 19/00

(52) U.S. Cl. 172/780

(57) ABSTRACT

An implement control system may include an operator interface having a grip movable to a pose relative to an operator interface frame of reference. A grip position sensor may detect the grip pose and generate a grip pose signal, and a controller communicatively coupled to the grip position sensor may receive the grip pose signal and generating an implement control signal. An implement assembly may include an implement supported for movement relative to a machine frame of reference and a plurality of actuators operably coupled to the implement and communicatively coupled to the controller. The plurality of implement actuators is configured to actuate in response to the implement control signal to drive the implement toward an implement pose relative to the machine frame of reference that corresponds to the grip pose.

### TECHNICAL FIELD

The present disclosure generally relates to operator interfaces, and more particularly to operator interfaces for controlling an implement provided on a machine.

### BACKGROUND

Operator interfaces are commonly provided to permit an operator to control one or more systems on a machine. The operator interface typically includes a user-engageable portion that may be moved or otherwise manipulated in a predetermined manner. Position sensors may detect the position and/or orientation of the user-engageable portion and communicate a position signal to a controller. The controller, in turn, generates a command signal that corresponds to the position signal and communicates the command signal to one or more components on the machine, thereby to execute a desired operation. Such operator interfaces are often provided to control steering and speed of the machine, or secondary functions such as work implements.

Operator interfaces provided for work implements capable of performing complex movements, such as work implements that may simultaneously translate along or rotate about multiple axes, are often difficult or overly complex to manipulate. The blade of a motor grader, for example, is capable of moving in multiple degrees of freedom to a desired position and orientation that efficiently sculpts a surface of terrain. Accordingly, the blade may be moved laterally along an X-axis, raised or lowered along a Z-axis, or rotated about three orthogonal rotational axes. One or more joysticks, such as the control lever disclosed in U.S. Pat. No. 6,681,880 to Bernhardt et al., are conventionally provided as the operator interface for the blade. There joysticks, however, are limited in the degrees of freedom about which they may move, and therefore the movement of the joystick does not always directly match the movement of the blade. Additionally, multiple joysticks are often provided for manipulating a single work implement, and therefore simultaneous and potentially complex joystick movements are needed to actuate the blade. Thus, the operator may find the use of conventional joysticks to control the position and orientation of a motor grader blade overly difficult and confusing.

### SUMMARY OF THE DISCLOSURE

In accordance with one aspect of the disclosure, an implement control system is provided for a machine having a frame defining a machine frame of reference. The implement control system may include an operator interface having a base defining an operator interface frame of reference including a first grip linear axis, a second grip linear axis perpendicular to the first grip linear axis, a third grip linear axis perpendicular to both the first grip linear axis and the second grip linear axis, a first grip rotational axis substantially parallel to the first grip linear axis, a second grip rotational axis substantially parallel to the second grip linear axis, and a third grip rotational axis substantially parallel to the third grip linear axis. A grip is coupled to the base and configured for grasping by a hand of a user. The grip may be supported for movement relative to the base in at least four grip axes selected from a group of grip axes consisting of the first grip linear axis, the second grip linear axis, the third grip linear axis, the first grip rotational axis, the second grip rotational axis, and the third grip rotational axis, wherein the grip is movable from a grip neutral position to a grip pose in which the grip deviates from the grip neutral position in at least one of the grip axes. The implement control system may further include a grip position sensor for detecting the grip pose configured to generate a grip pose signal, and a controller communicatively coupled to the grip position sensor for receiving the grip pose signal and generating a set of implement control signals. An implement assembly may include an implement coupled to the frame and supported for movement relative to the frame in the machine frame of reference, and a plurality of implement actuators operably coupled to the implement and communicatively coupled to the controller, wherein the plurality of implement actuators are configured to actuate in response to the set of implement control signals to drive the implement toward an implement pose relative to the machine frame of reference that corresponds to the grip pose as defined by the operator interface frame of reference.

In another aspect of the disclosure that may be combined with any of these aspects, a machine may have a frame defining a machine frame of reference including a first implement linear axis, a second implement linear axis perpendicular to the first implement linear axis, a third implement linear axis perpendicular to both the first implement linear axis and the second implement linear axis, a first implement rotational axis substantially parallel to the first implement linear axis, a second implement rotational axis substantially parallel to the second implement linear axis, and a third implement rotational axis substantially parallel to the third implement linear axis. An operator interface is coupled to the frame and includes a base defining an operator interface frame of reference including a first grip linear axis, a second grip linear axis perpendicular to the first grip linear axis, a third grip linear axis perpendicular to both the first grip linear axis and the second grip linear axis, a first grip rotational axis substantially parallel to the first grip linear axis, a second grip rotational axis substantially parallel to the second grip linear axis, and a third grip rotational axis substantially parallel to the third grip linear axis. A grip is coupled to the base and configured for grasping by a hand of a user, the grip being supported for movement relative to the base in at least four grip axes selected from a group of grip axes consisting of the first grip linear axis, the second grip linear axis, the third grip linear axis, the first grip rotational axis, the second grip rotational axis, and the third grip rotational axis, wherein the grip is movable from a grip neutral position to a grip pose in which the grip deviates from the grip neutral position in at least one of the grip axes, and a grip position sensor for detecting the grip pose configured to generate a grip pose signal. A controller may be communicatively coupled to the grip position sensor for receiving the grip pose signal and generating a set of implement control signals. An implement assembly may include an implement coupled to the frame and supported for movement relative to the machine frame of reference in at least four implement axes selected from a group of implement axes consisting of the first implement linear axis, the second implement linear axis, the third implement linear axis, the first implement rotational axis, the second implement rotational axis, and the third implement rotational axis, and a plurality of implement actuators operably coupled to the implement and communicatively coupled to the controller, wherein the plurality of implement actuators is configured to actuate in response to the set of implement control signals to drive the implement toward an implement pose relative to the machine frame of reference that corresponds to the grip pose as defined by the operator interface frame of reference.

In another aspect of the disclosure that may be combined with any of these aspects, an implement control system is provided for a motor grader having a frame defining a machine frame of reference. The implement control system may have an operator interface including a base defining an operator interface frame of reference that includes a first grip linear axis, a second grip linear axis perpendicular to the first grip linear axis, a third grip linear axis perpendicular to both the first grip linear axis and the second grip linear axis, a first grip rotational axis substantially parallel to the first grip linear axis, a second grip rotational axis substantially parallel to the second grip linear axis, and a third grip rotational axis substantially parallel to the third grip linear axis. A grip is coupled to the base and configured for grasping by a hand of a user, the grip being supported for translation relative to the base in the first grip linear axis and the second grip linear axis, the grip further being rotatable about the first grip rotational axis, the second grip rotational axis, and the third grip rotational axis, wherein the grip is movable from a grip neutral position to a grip pose in which the grip deviates from the grip neutral position in at least one of the grip axes, and a grip position sensor for detecting the grip pose configured to generate a grip pose signal. A controller is communicatively coupled to the grip position sensor for receiving the grip pose signal and generating a set of implement control signals. An implement assembly may include a motor grader implement coupled to the frame and supported for movement relative to the frame in the machine frame of reference, and a plurality of actuators operably coupled to the motor grader implement and communicatively coupled to the controller, wherein the plurality of actuators are configured to actuate in response to the set of implement control signals to drive the motor grader implement toward an implement pose relative to the machine frame of reference that corresponds to the grip pose as defined by the operator interface frame of reference.

In another aspect of the disclosure that may be combined with any of these aspects, the controller is configured to generate a set of grip pose components based on the grip pose signal, wherein each grip pose component represents a deviation of the grip from the grip neutral position relative to one of the grip axes, identify a set of selected implement actuators associated with the set of grip pose components, and communicate the set of implement control signals to the set of selected implement actuators.

In another aspect of the disclosure that may be combined with any of these aspects, the controller is further configured to quantify a magnitude of deviation for each grip pose component, and wherein each implement control signal is proportional to the magnitude of deviation in an associated grip axis.

In another aspect of the disclosure that may be combined with any of these aspects, the grip is supported for movement relative to the base in the first grip linear axis, the second grip linear axis, the first grip rotational axis, the second grip rotational axis, and the third grip rotational axis.

In another aspect of the disclosure that may be combined with any of these aspects, the first grip linear axis comprises a substantially vertical grip axis and the second grip linear axis comprises a substantially lateral grip axis.

In another aspect of the disclosure that may be combined with any of these aspects, the plurality of implement actuators includes a lift actuator configured to translate the implement along a substantially vertical implement axis, and in which movement of the grip along the vertical grip axis drives the lift actuator.

In another aspect of the disclosure that may be combined with any of these aspects, the plurality of implement actuators includes a side shift actuator configured to translate the implement along a substantially lateral implement axis, and in which movement of the grip along the lateral grip axis drives the side shift actuator.

In another aspect of the disclosure that may be combined with any of these aspects, the plurality of implement actuators includes a circle drive configured to rotate the implement around a substantially vertical implement rotational axis, and in which rotation of the grip around the first grip rotational axis actuates the circle drive.

In another aspect of the disclosure that may be combined with any of these aspects, the plurality of implement actuators includes a tip actuator configured to rotate the implement around a substantially lateral implement rotational axis, and in which rotation of the grip around the second grip rotational axis drives the tip actuator.

In another aspect of the disclosure that may be combined with any of these aspects, the plurality of implement actuators includes first and second lift actuators configured to rotate the implement around a substantially longitudinal implement rotational axis, and in which rotation of the grip around the third grip rotational axis drives the first and second lift actuators.

In another aspect of the disclosure that may be combined with any of these aspects, the machine comprises a motor grader and the implement comprises a motor grader implement.

In another aspect of the disclosure that may be combined with any of these aspects, a filter is operably coupled to the operator interface and configured to receive the grip pose signal and disable a component of the grip pose signal associated with at least one grip axis selected from a group of grip axes consisting of the first grip linear axis, the second grip linear axis, the third grip linear axis, the first grip rotational axis, the second grip rotational axis, and the third grip rotational axis. In another aspect of the disclosure that may be combined with any of these aspects, the grip pose includes a dominant input corresponding to a component of the grip pose having the largest deviation from a normal grip position along one of the first grip linear axis, the second grip linear axis, the third grip linear axis, the first grip rotational axis, the second grip rotational axis, and the third grip rotational axis, the implement control system further comprising a filter operably coupled to the operator interface and configured to receive the grip pose signal and provide a filtered grip pose signal including only a grip pose signal component corresponding to the dominant input of the grip pose.

In another aspect of the disclosure that may be combined with any of these aspects, a haptic feedback system is operably coupled to the operator interface and configured to generate a tactile feedback force on the grip.

In another aspect of the disclosure that may be combined with any of these aspects, the operator interface is positioned remotely from the implement assembly.

### BRIEF DESCRIPTION OF THE DRAWINGS

FIG. 1 is a side view of a motor grader.

FIG. 2 is a top view of the motor grader of FIG. 1.

FIG. 3 is a top schematic view of the motor grader of FIG. 2 rotated to a full right articulation angle.

FIG. 4 is a schematic illustration of an exemplary control system incorporating the operator interface.

FIG. 5 is an enlarged, schematic perspective view of the operator interface.

FIG. 6 is a block diagram of a control circuit for the operator interface illustrated in FIG. 5.

### DETAILED DESCRIPTION

Embodiments of an operator interface are disclosed for use in an implement control system provided on a machine. In the exemplary embodiments described herein, the machine is a motor grader having a blade as the implement. The operator interface includes a grip for engagement by the user that can be translated along and rotated about multiple axes. Accordingly, the operator may hold the grip in a position and orientation that directly corresponds to the position and orientation of the blade, thereby providing a more intuitive operator interface. The position and orientation of an object (such as the grip or the blade) is referred to herein as a “pose.”

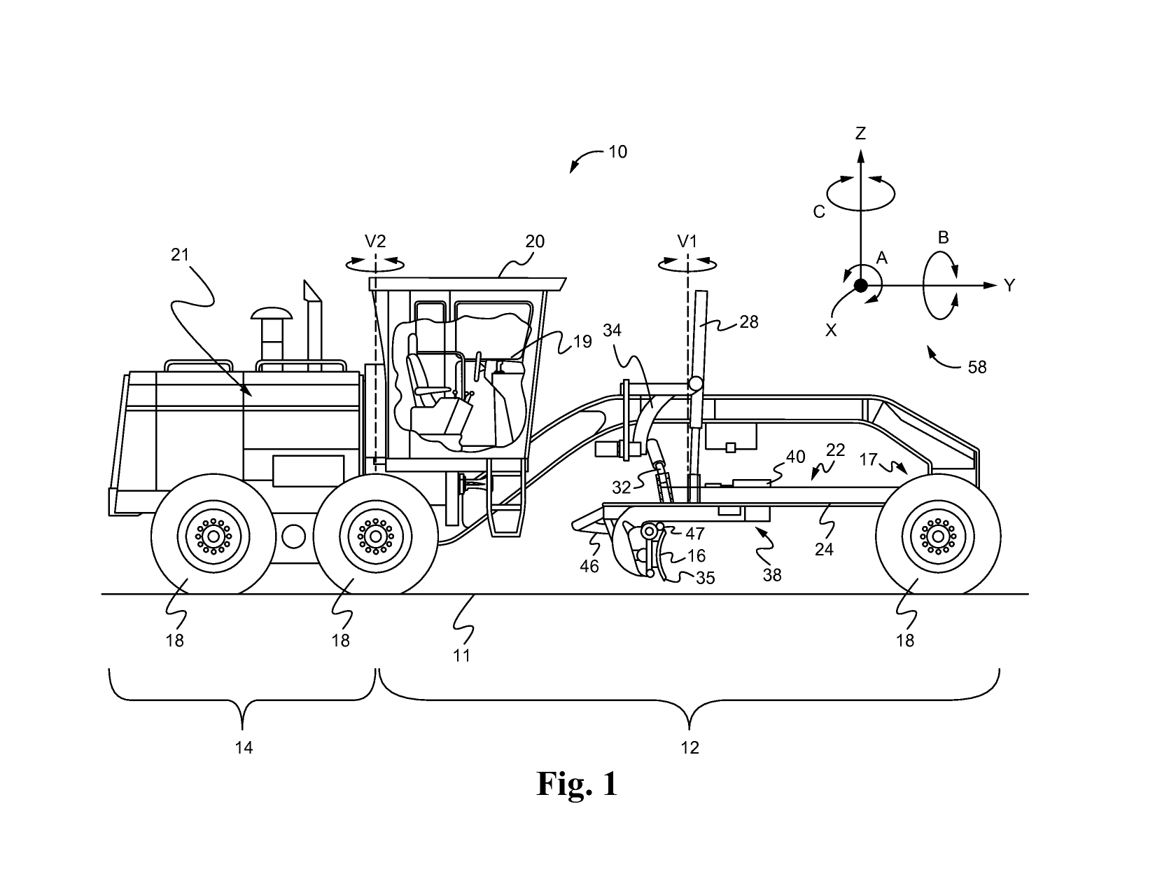

Referring to FIGS. 1-3, a motor grader is shown generally at 10. The motor grader 10 is used primarily as a finishing tool to sculpt a surface of earth 11 to a final arrangement. Rather than moving large quantities of earth in the direction of travel like other machines, such as a bulldozer, the motor grader 10 typically moves relatively small quantities of earth from side to side. In other words, the motor grader 10 typically moves earth across the area being graded, not straight ahead.

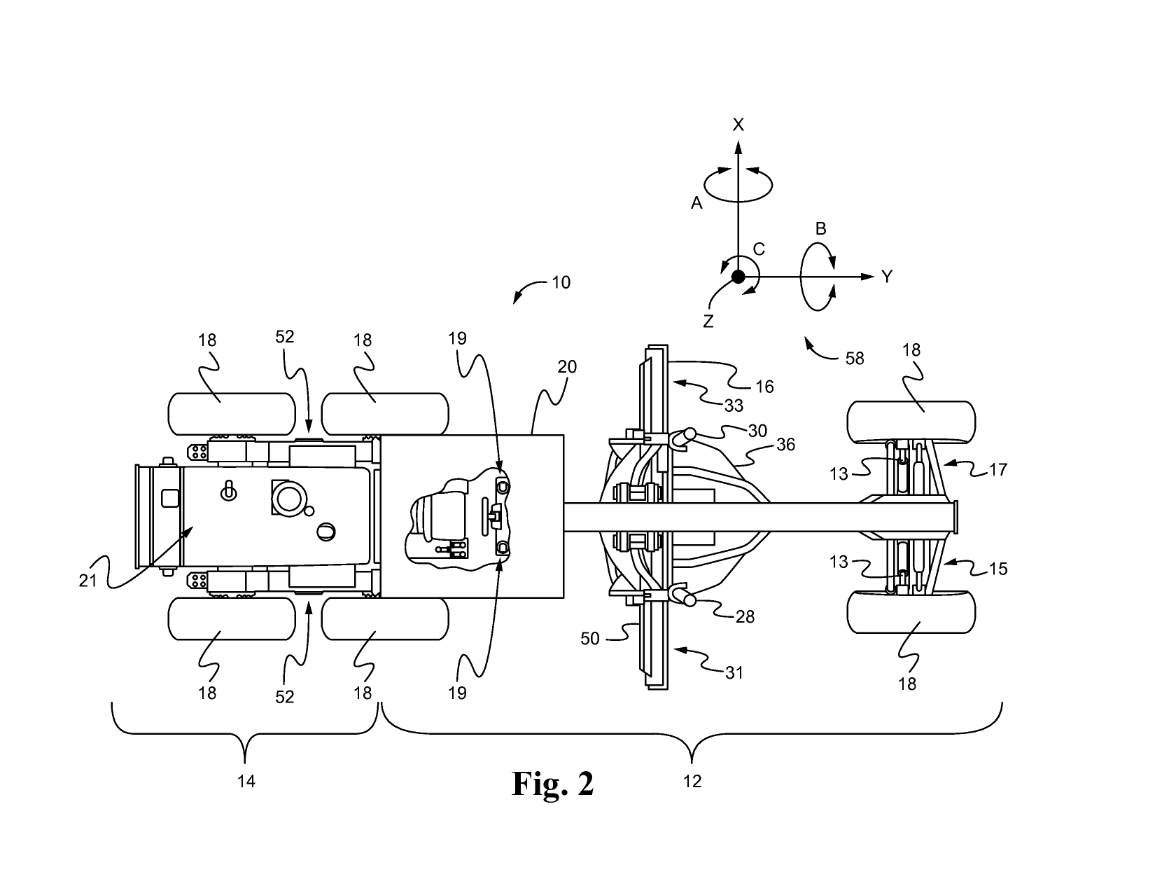

The motor grader 10 includes a front frame 12, a rear frame 14, and a motor grader implement, such as a blade 16. The front and rear frames 12 and 14 are supported by wheels 18. An operator cab 20, containing many controls 19 necessary to operate the motor grader 10, is mounted on the front frame 12. The controls 19 illustrated in FIGS. 1 and 2 are indicative of a complex multiple lever-controlled system of the prior art. An engine, transmission, and differential axle, collectively comprise a vehicle drive system shown generally at 21 mounted on the rear frame 14. The vehicle drive system 21 is used to drive or power the motor grader 10. The transmission includes a plurality of forward and reverse gears and a neutral gear in which none of the forward and reverse gears are engaged. Motor grader transmissions often have up to eight forward gears and eight reverse gears. The transmission is connected to a differential axle having a wheel 18 on each side that may be locked so that both wheels 18 may be driven during slippery conditions.

A vehicle steering system 17 includes steering actuators 13 that turn the wheels 18 on the front frame 12. The vehicle steering system 17 also includes a wheel lean actuator 15 that tilts the wheels 18 on the front frame 12 from left to right.

The blade 16, sometimes referred to as a moldboard, is used to move earth. The blade 16 is mounted on a linkage assembly, shown generally at 22. The linkage assembly 22 allows the blade 16 to be moved to a variety of different positions relative to the motor grader 10.

The linkage assembly 22 includes a drawbar 24 mounted to the front frame 12 by a ball joint. The position of the drawbar 24 is controlled by three hydraulic actuators, commonly referred to as a right lift actuator 28, a left lift actuator 30, and a center shift actuator 32. A coupling, shown generally at 34, connects the three actuators 28, 30, and 32 to the front frame 12. The coupling 34 can be moved during blade repositioning but is fixed stationary during earthmoving operations. The height of the blade 16 with respect to the surface of earth 11 below the motor grader 10, commonly referred to as blade height, is controlled primarily with the right and left lift actuators 28 and 30. The right and left lift actuators 28 and 30 are connected to right 31 and left 33 portions of the blade 16 respectively. The actuators 28, 30 can be controlled independently and, thus, used to angle a bottom cutting edge 35 of the blade 16 relative to the surface of earth 11. The center shift actuator 32 is used primarily to side shift the drawbar 24, and all the components mounted to the end of the drawbar including the blade 16, relative to the front frame 12. This side shift is commonly referred to as drawbar side shift or circle center shift.

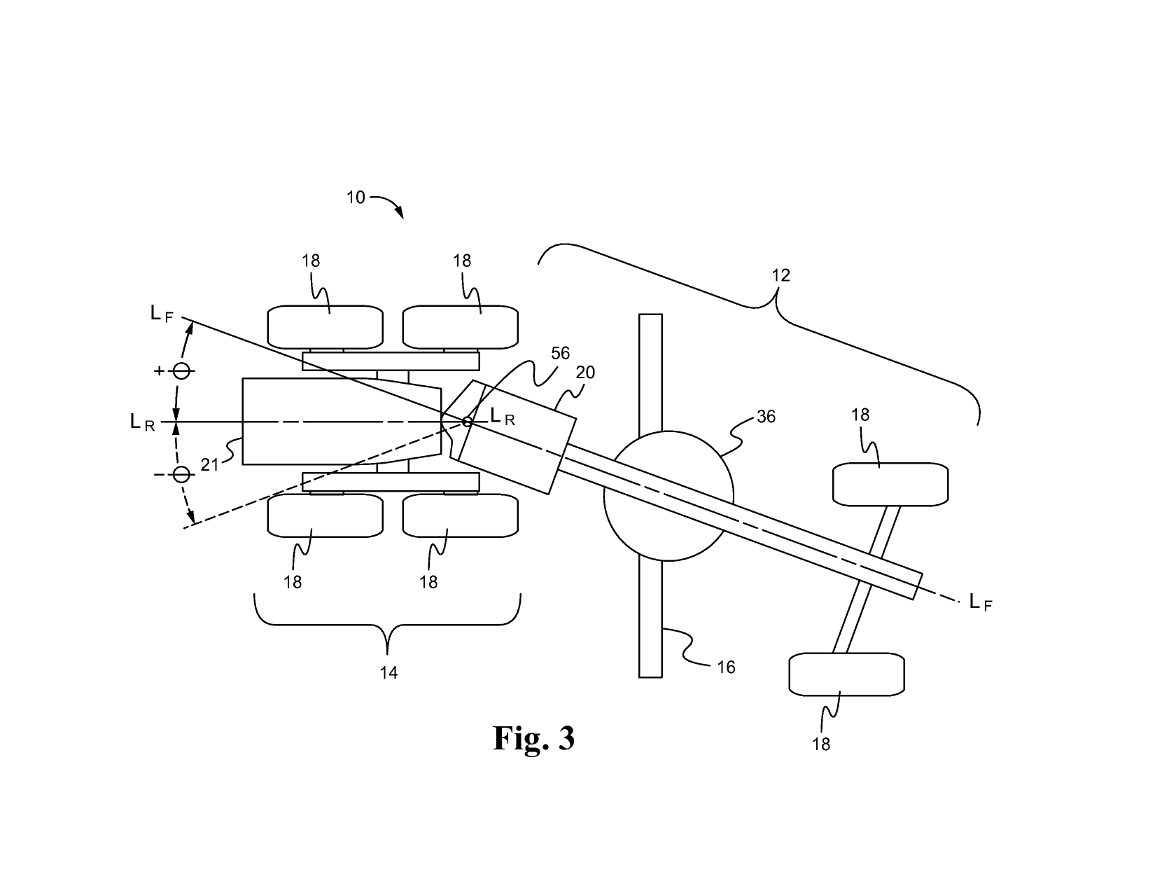

The drawbar 24 includes a large, flat plate, commonly referred to as a yoke plate 36, as shown in FIGS. 2 and 3. Beneath the yoke plate 36 is a large gear, commonly referred to as a circle 38. The circle 38 is rotated by a hydraulic motor, commonly referred to as a circle drive 40, as shown in FIG. 1. The rotation of the circle 38 by the circle drive 40, commonly referred to as circle turn, pivots the blade 16 about a first vertical axis V1 fixed to the drawbar 24 to establish a blade cutting angle. The blade cutting angle is defined as the angle of the blade 16 relative to the front frame 12. At a zero degree blade cutting angle, the blade 16 is aligned at a right angle to the front frame 12. In FIG. 2, the blade 16 is set at a zero degree blade cutting angle.

The blade 16 is mounted to a hinge on the circle 38 with a bracket. A blade tip actuator 46 is used to pitch the bracket forward or rearward. In other words, the blade tip actuator 46 is used to tip or tilt a top edge 47 of the blade 16 ahead of or behind the bottom cutting edge 35 of the blade 16. The position of the top edge 47 of the blade 16 relative to the bottom cutting edge 35 of the blade 16 is commonly referred to as blade tip.

The blade 16 is mounted to a sliding joint in the bracket allowing the blade 16 to be slid or shifted from side to side relative to the bracket or the circle 38. This side-to-side shift is commonly referred to as blade side shift. A side shift actuator 50 is used to control the blade side shift.

Referring now to FIG. 2, a right articulation actuator, shown generally at 52, is mounted to the right side of the rear frame 14 and a left articulation actuator, shown generally at 54, is mounted to the left side of the rear frame 14. The right and left articulation actuators 52 and 54 are used to rotate the front frame 12 about a second vertical axis V2 shown in FIG. 1. The axis V2 is commonly referred to as the articulation axis. In FIG. 2, the motor grader 10 is positioned in a neutral or zero articulation angle.

FIG. 3 is a top schematic view of the motor grader 10 with the front frame 12 rotated to a full right articulation angle θ. The articulation angle θ is formed by the intersection of the longitudinal axis L_{F} of the front frame 12 and the longitudinal axis L_{R} of the rear frame 14. An articulation joint 56 connects the front frame 12 and the rear frame 14. A rotary sensor, used to measure the articulation angle θ, is positioned at the articulation joint 56. A full left articulation angle θ, shown in phantom lines in FIG. 3, is a mirror image of the full right articulation angle θ. The motor grader 10 may be operated with the front frame 12 rotated to the full right articulation angle θ, the full left articulation angle θ, or any angle therebetween.

The individual motors, pumps, sump, etc., have not been illustrated for the sake of brevity. It will be appreciated that any appropriate arrangement may be provided in this regard, within the spirit of this disclosure.

The above-described blade 16 is therefore capable of movement in five degrees of freedom relative to a machine frame of reference 58 defined by the motor grader 10. As best shown with reference to FIGS. 1 and 3, the machine frame of reference 58 may define directions of movement relative to the front frame 12, and may include linear axes such as a linear lateral axis X, a linear longitudinal axis Y (which is the direction the motor grader 10 moves when traveling in a straight line), and a linear vertical axis Z. The X, Y, and Z-axes may be orthogonal to one another. The machine frame of reference may further include rotational axes, such as a rotational pitch axis A, a rotational roll axis B, and a rotational yaw axis C. The rotational pitch axis A may be substantially parallel to the linear lateral axis X, the rotational roll axis B may be substantially parallel to the linear longitudinal axis Y, and the rotational yaw axis C may be substantially parallel to the linear vertical axis Z. Movement of the blade 16 may therefore be described by reference to axes provided by the machine frame of reference 58.

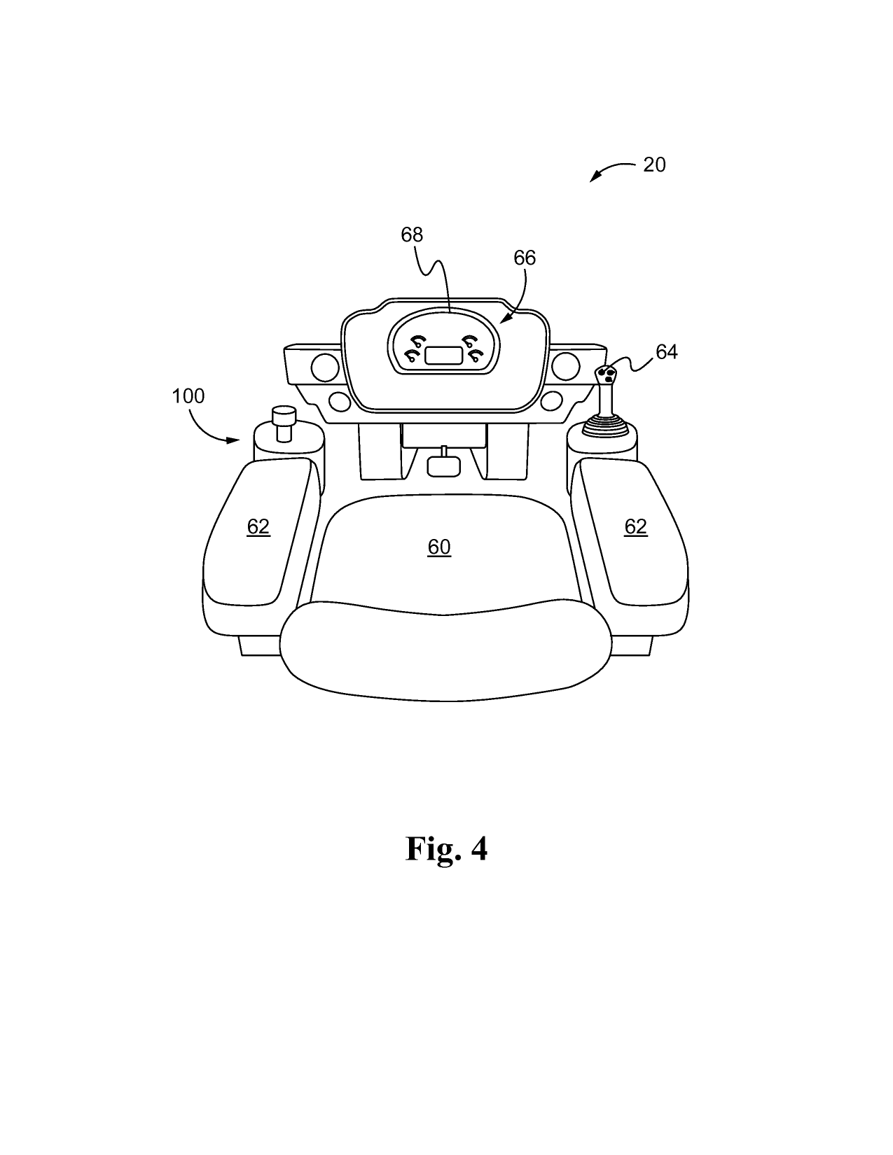

As noted above, the operator cab 20 may be supported along the front frame 12. An exemplary interior of the cab 20 is illustrated in FIG. 4 and includes a seat 60, arm rests 62, a steering mechanism 64, and a console 66 including a display 68. An operator occupying the cab 20 can control the various functions and motion of the motor grader 10, for example, by using the steering mechanism 64 to set a direction of travel for the motor grader 10. With the exception of the implement operator interface 100 used to control the blade 16, described in greater detail below, the representations of the various control mechanisms presented herein are generic and are meant to encompass all possible mechanisms or devices used to convey an operator's commands to a machine, including, for example, so-called joystick operation. While an operator cab 20 is shown in the illustrated embodiments, the inclusion of such a cab 20 and associated seat 60, steering mechanism 64, operator interface 100, and console 66 are optional in that the motor grader 10 could alternately be autonomous, that is, the motor grader 10 may be remotely controlled by a control system that does not require operation by an on-board human operator.

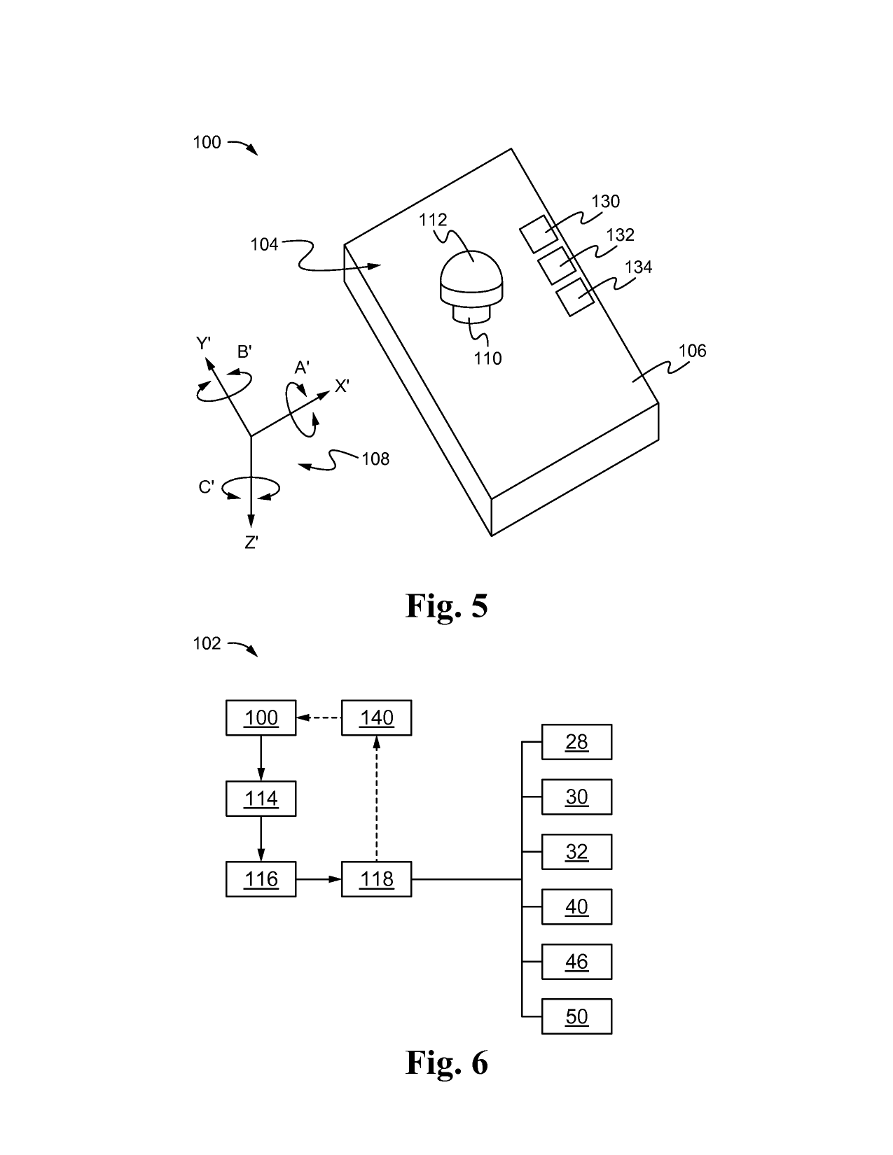

FIGS. 5 and 6 show an exemplary operator interface 100 in greater detail and incorporated into an implement control system 102. Referring first to FIG. 5, the illustrated implement operator interface 100 has a base 104 that may include a lower portion 106 defining a support for the operator's hand and/or arm. The base 104 further defines a frame of reference 108 for the operator interface 100. The operator interface frame of reference 108 includes six grip axes, such as a lateral linear axis X′, a longitudinal linear axis Y′, a vertical linear axis Z′, a rotational pitch axis A′, a rotational roll axis B′, and a rotational yaw axis C′. The axes of the operator interface frame of reference 108 may be parallel to their counterparts in the machine frame of reference 58, particularly when the operator interface 100 is mounted on the motor grader 10. The grip axes, however, need not be parallel to their counterpart machine axes, especially when the operator interface 100 is provided remotely (such as when the motor grader 10 is unmanned and controlled remotely).

A pedestal 110 extends upwardly from the base 104 and supports a grip 112. The grip 112 is configured to be grasped by a hand of the user and is supported for movement relative to the pedestal 110 in one or more of the three linear axes and three rotational axes noted above. Accordingly, the grip 112 is movable from a grip neutral position in which the grip normally resides, such as that shown in FIG. 5, to a grip pose (i.e., a grip position and orientation) in which the grip deviates from the grip neutral position in at least one of the grip axes.

The grip 112 may be formed in any shape that is convenient to the operator. In the illustrated embodiment, the grip 112 has a semi-spherical shape that may provide an ergonomic fit with the operator's hand. Other shapes, however, may be used without departing from the scope of the appended claims. The grip 112 may further be configured to provide a visual representation of the work implement associated therewith. In the illustrated embodiment, for example, the grip 112 may include an icon or other graphical representation depicting a motor grader blade. Additionally or alternatively, the grip 112 may be formed in the shape of the work implement, which in the current embodiment would be the shape of the blade 16.

As best shown in FIG. 6, the implement control system 102 may further include a grip position sensor 114 operatively coupled to the operator interface 100 and configured to detect the grip pose and generate a grip pose signal. The grip position sensor 114 may include one or more position sensors which detect the position and/or orientation of the grip 112. The position sensors may generate a grip pose signal that is indicative of a deviation of the grip 112 from the grip neutral position.

One or more filters 116 may be operatively coupled to the position sensors to condition the grip pose signal as desired. For example, the filters 116 may be low pass filters that filter out high frequency jitter provided by the grip position sensor 114, thereby filtering out very rapid movements of the grip 112. The filters 116 may be implemented in hardware using one of any number of conventional filtering techniques. Additionally or alternatively, the filters 116 may be implemented in the software associated with a controller 118 that receives the grip pose signal.

The controller 118 is communicatively coupled to the grip position sensor 114 to receive the grip pose signal (with or without filtering) and generate a set of implement control signals. The controller may be a digital computer, microcontroller, processor, or other type of control component with associated memory and timing circuitry. The set of implement control signals may include a single implement control signal or a plurality of implement control signals. The controller may be configured to separate the grip pose signal into a set of grip pose components, wherein each grip pose component represents a deviation of the grip from the grip neutral position relative to a selected one of the six grip axes. Based on the grip pose components that are generated, the controller may further be configured to identify a set of selected implement actuators that are associated with the grip pose components, and communicate the set of implement control signals to the set of selected implement actuators. The controller may also be configured to quantify a magnitude of deviation for each grip pose component and deliver an implement control signal that is proportional to the magnitude of deviation in the associated grip axis.

The implement control signal generated by the controller 118 is communicated to one or more selected actuators operatively coupled to the blade 16 (such as the right lift actuator 28, the left lift actuator 30, the center shift actuator 32, the circle drive 40, the blade tip actuator 46, and the side shift actuator 50), which then actuate as commanded by the control signal. One or more of the actuators then drive the blade 16 toward implement pose relative to the machine frame of reference 58 that corresponds to the grip pose as defined by the operator interface frame of reference.

The implement pose is a theoretical implement position and orientation as determined relative to the machine frame of reference 58 that generally corresponds to the grip pose as determined relative to the operator interface frame of reference 108. Because the actuators are not instantaneous, but instead require a period of time to execute a commanded operation, the implement is initially driven toward the theoretical implement pose. It is possible for the operator to halt movement of the implement prior to reaching the implement pose by returning the grip 112 to the grip neutral position. Conversely, the implement may be actuated past the implement pose should the operator continue to hold the grip in a selected grip pose for an extended period of time. Furthermore, the rate at which the actuators move may be proportional to the magnitude of deviation of the grip from the grip neutral position. Accordingly, the theoretical implement pose may be represented by the set of grip pose components, each of which indicates an actual movement of the grip along one of the grip axes, which are then mapped over to the actuators capable of executing a corresponding movement of the implement in a corresponding implement axis.

A plurality of switches 130, 132, 134 may be provided to customize the output provided by the operator interface 100. The switches 130, 132, 134 may be selectively engaged or disengaged to employ the one or more filters 116 to condition the grip pose signal in a desired manner. For example, the switch 130 may be a “dominant input” switch. When the dominant input switch is activated, the grip pose signal is filtered so that movement in only one axis is permitted. The grip pose may include a dominant input corresponding to a component of the grip pose having the largest deviation from a normal grip position along one of the first grip linear axis, the second grip linear axis, the first grip rotational axis, the second grip rotational axis, and the third grip rotational axis. The filter may be configured to receive the grip pose signal and provide a filtered grip pose signal including only a grip pose signal component corresponding to the dominant input of the grip pose. Accordingly, the only axis along which the implement is permitted to move is the axis corresponding to the dominant input of grip movement. The dominant input may change as the operator continues to manipulate the grip, so movement in several axes is permitted in dominant input mode, however only sequentially and not simultaneously.

The switch 132 may be a “linear lock” switch. When the linear lock switch is activated, the grip pose signal is filtered to remove the linear axes components (i.e., the X, Y, and Z-axes components), so that movement is permitted only about the rotational axes (i.e., the A, B, and C-axes).

The switch 134 may be a “rotation lock” switch. When the rotation lock switch is active, the grip pose signal is filtered to remove the rotational axes components (i.e., the A, B, and C-axes), so that movement is permitted only along the linear axes (i.e., the X, Y, and Z-axes). Additional switches having other custom features for filtering or otherwise conditioning the grip pose signal may also be provided.

The operator interface 100 may further include a haptic feedback system 140 for providing a tactile feedback force to the operator. The haptic feedback system 140, also commonly referred to as a force feedback system, may provide physical sensations to the user manipulating the grip 112. The haptic feedback system 140 may include motors or other actuators that are operatively coupled to the grip 112 and are connected to the controller 118. Based on the grip pose signal, the controller 118 may send appropriate force feedback control signals to the actuators, which then provide a tactile feedback force on the grip 112.

### INDUSTRIAL APPLICABILITY

The present disclosure is applicable to machines that use a control system having an operator interface for controlling position of a work implement. In the exemplary motor grader, the operator interface 100 is operably coupled to the blade 16. The blade 16 is configured for movement in five degrees of freedom, namely a linear lateral axis X, a linear vertical axis Z, a rotational pitch axis A, a rotational roll axis B, and a rotational yaw axis C. The operator interface 100 includes a grip 112 that is likewise movable in five corresponding degrees of freedom, namely a liner lateral axis X′, a linear vertical axis Z′, a rotational pitch axis A′, a rotational roll axis B′, and a rotational yaw axis C′. By providing a single grip 112 that can be manipulated in the same degrees of freedom as the blade 16, the grip 112 may be moved in a pose that directly corresponds to the desired pose of the blade 16, thereby making blade position control more intuitive.

Specific movements of the blade 16 may be mapped to corresponding movements of the grip 112. For example, movement of the blade 16 in the Z-axis to control blade height may be mapped to raising/lowering the grip 112 along the Z′-axis. Thus, when the grip 112 is moved along the Z′-axis, the left and right lift actuators 28, 30 are operated to adjust blade height.

Movement of the blade 16 along the X-axis to control lateral blade position may be mapped to translating the grip 112 to either side along the X′-axis. Thus, when the grip 112 is moved along the X′-axis, the side shift actuator 50 is operated to adjust lateral blade position.

Rotation of the blade 16 about the A-axis to control blade pitch angle may be mapped to rotation of the grip 112 about the A′-axis. Thus, when the grip 112 is rotated about the A′-axis, the blade tip actuator 46 is operated to adjust blade tip or pitch angle.

Rotation of the blade 16 about the B-axis to control blade bottom edge angle may be mapped to rotation of the grip 112 about the B′-axis. Thus, when the grip 112 is rotated about the B′-axis, the left and/or right lift actuators 28, 30 are operated to adjust blade bottom angle.

Rotation of the blade 16 about the C-axis to control circle rotation angle may be mapped to rotation of the grip 112 about the C′-axis. Thus, when the grip 112 is rotated about the C′-axis, the circle drive 40 is actuated to adjust circle rotation angle.

In the exemplary embodiment, the operator interface 100 has a further degree of freedom along the Y′-axis that is not used to control blade movement, because the blade 16 is not capable of movement along the longitudinal Y-axis. Accordingly, another function of the motor grader 10 may be mapped to translational movement of the grip 112 along the Y′-axis. For example, Y′-axis movement of the grip 112 may be used to control direction of machine travel, shifting of the machine transmission, engine speed, or any other function associated with the machine or another implement provided on the machine.

While the exemplary embodiments control a blade 16 of a motor grader, it will be appreciated that the implement control system disclosed herein may be used on other types of machines, including but not limited to, track type tractors, excavators, and wheel loaders. Still further, the implement control system may be used with implements other than a blade. For example, alternative motor grader implements may include snow wings, plows, scarifiers, lift groups, and other implements used on motor graders. The implement control system may be used with other types of implements that are typically used with other types of machines, including but not limited to augurs, asphalt cutters, backhoes, blades, brooms, brushcutters, buckets, carriages, cold planers, compactors, couplers, cutters, forks, grapples, hammers, lifting hooks, material handling arms, mulchers, multi-processors, plows, rakes, rippers, scoops, self-tipping hoppers, shears, snow blowers, stump grinders, thumbs, tillers, trenchers, truss booms, vibratory drum compactors, vibratory plate compactors, wheel saws, and winches.

While the motor grader embodiment disclosed herein provides a blade that can be moved in five degrees of freedom, it will be appreciated that applications on other machines or with other implements may be capable of moving in greater than or less than five degrees of freedom. Furthermore, regardless of the number of degrees of freedom in which the implement may move, the specific degrees of freedom for each implement may be different. For example, a track type tractor may have a bulldozer blade that is movable in four degrees of freedom: (1) along a linear, substantially vertical axis Z, (2) about a rotational pitch axis A, (3) about a rotational roll axis B, and (4) about a rotational yaw axis C. In such an embodiment, the grip 112 of the operator interface 100 may similarly be operable in only four degrees of freedom to control the pose of the bulldozer blade.

It will be appreciated that the foregoing description provides examples of the disclosed assembly and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. An implement control system for a machine having a frame defining a machine frame of reference, the implement control system comprising:
an operator interface including:
a base defining an operator interface frame of reference, the operator interface frame of reference including a first grip linear axis, a second grip linear axis perpendicular to the first grip linear axis, a third grip linear axis perpendicular to both the first grip linear axis and the second grip linear axis, a first grip rotational axis substantially parallel to the first grip linear axis, a second grip rotational axis substantially parallel to the second grip linear axis, and a third grip rotational axis substantially parallel to the third grip linear axis;
a grip coupled to the base and configured for grasping by a hand of a user, the grip being supported for movement relative to the base in at least four grip axes selected from a group of grip axes consisting of the first grip linear axis, the second grip linear axis, the third grip linear axis, the first grip rotational axis, the second grip rotational axis, and the third grip rotational axis, wherein the grip is movable from a grip neutral position to a grip pose in which the grip deviates from the grip neutral position in at least one of the grip axes; and
a grip position sensor for detecting the grip pose configured to generate a grip pose signal;
a controller communicatively coupled to the grip position sensor for receiving the grip pose signal and generating a set of implement control signals; and
an implement assembly including:
an implement coupled to the frame and supported for movement relative to the frame in the machine frame of reference; and
a plurality of implement actuators operably coupled to the implement and communicatively coupled to the controller, wherein the plurality of implement actuators are configured to actuate in response to the set of implement control signals to drive the implement toward an implement pose relative to the machine frame of reference that corresponds to the grip pose as defined by the operator interface frame of reference.

2. The implement control system of claim 1, in which the controller is configured to:
generate a set of grip pose components based on the grip pose signal, wherein each grip pose component represents a deviation of the grip from the grip neutral position relative to one of the grip axes;
identify a set of selected implement actuators associated with the set of grip pose components; and
communicate the set of implement control signals to the set of selected implement actuators.

3. The implement control system of claim 2, in which the controller is further configured to:
quantify a magnitude of deviation for each grip pose component, wherein each implement control signal is proportional to the magnitude of deviation in an associated grip axis.

4. The implement control system of claim 1, in which the grip is supported for movement relative to the base in the first grip linear axis, the second grip linear axis, the first grip rotational axis, the second grip rotational axis, and the third grip rotational axis.

5. The implement control system of claim 4, in which the first grip linear axis comprises a substantially vertical grip axis and the second grip linear axis comprises a substantially lateral grip axis.

6. The implement control system of claim 5, in which the plurality of implement actuators includes a lift actuator configured to translate the implement along a substantially vertical implement axis, and in which movement of the grip along the vertical grip axis drives the lift actuator.

7. The implement control system of claim 5, in which the plurality of implement actuators includes a side shift actuator configured to translate the implement along a substantially lateral implement axis, and in which movement of the grip along the lateral grip axis drives the side shift actuator.

8. The implement control system of claim 5, in which the plurality of implement actuators includes a circle drive configured to rotate the implement around a substantially vertical implement rotational axis, and in which rotation of the grip around the first grip rotational axis actuates the circle drive.

9. The implement control system of claim 5, in which the plurality of implement actuators includes a tip actuator configured to rotate the implement around a substantially lateral implement rotational axis, and in which rotation of the grip around the second grip rotational axis drives the tip actuator.

10. The implement control system of claim 5, in which the plurality of implement actuators includes first and second lift actuators configured to rotate the implement around a substantially longitudinal implement rotational axis, and in which rotation of the grip around the third grip rotational axis drives the first and second lift actuators.

11. The implement control system of claim 1, in which the machine comprises a motor grader and the implement comprises a motor grader implement.

12. The implement control system of claim 1, further comprising a filter operably coupled to the operator interface and configured to receive the grip pose signal and disable a component of the grip pose signal associated with at least one grip axis selected from a group of grip axes consisting of the first grip linear axis, the second grip linear axis, the third grip linear axis, the first grip rotational axis, the second grip rotational axis, and the third grip rotational axis.

13. The implement control system of claim 1, in which the grip pose includes a dominant input corresponding to a component of the grip pose having the largest deviation from a normal grip position along one of the first grip linear axis, the second grip linear axis, the third grip linear axis, the first grip rotational axis, the second grip rotational axis, and the third grip rotational axis, the implement control system further comprising a filter operably coupled to the operator interface and configured to receive the grip pose signal and provide a filtered grip pose signal including only a grip pose signal component corresponding to the dominant input of the grip pose.

14. The implement control system of claim 1, further comprising a haptic feedback system operably coupled to the operator interface and configured to generate a tactile feedback force on the grip.

15. The implement control system of claim 1, in which the operator interface is positioned remotely from the implement assembly.

16. A machine comprising:
a frame defining a machine frame of reference, the machine frame of reference including a first implement linear axis, a second implement linear axis substantially perpendicular to the first implement linear axis, a third implement linear axis substantially perpendicular to the first implement linear axis and the second implement linear axis, a first implement rotational axis substantially parallel to the first implement linear axis, a second implement rotational axis substantially parallel to the second implement linear axis, and a third implement rotational axis substantially parallel to the third implement linear axis;
an operator interface coupled to the frame and including:
a base defining an operator interface frame of reference, the operator interface frame of reference including a first grip linear axis, a second grip linear axis perpendicular to the first grip linear axis, a third grip linear axis perpendicular to both the first grip linear axis and the second grip linear axis, a first grip rotational axis substantially parallel to the first grip linear axis, a second grip rotational axis substantially parallel to the second grip linear axis, and a third grip rotational axis substantially parallel to the third grip linear axis;
a grip coupled to the base and configured for grasping by a hand of a user, the grip being supported for movement relative to the base in at least four grip axes selected from a group of grip axes consisting of the first grip linear axis, the second grip linear axis, the third grip linear axis, the first grip rotational axis, the second grip rotational axis, and the third grip rotational axis, wherein the grip is movable from a grip neutral position to a grip pose in which the grip deviates from the grip neutral position in at least one of the grip axes; and
a grip position sensor for detecting the grip pose configured to generate a grip pose signal;
a controller communicatively coupled to the grip position sensor for receiving the grip pose signal and generating a set of implement control signals; and
an implement assembly including:
an implement coupled to the frame and supported for movement relative to the machine frame of reference in at least four implement axes selected from a group of implement axes consisting of the first implement linear axis, the second implement linear axis, the third implement linear axis, the first implement rotational axis, the second implement rotational axis, and the third implement rotational axis; and
a plurality of implement actuators operably coupled to the implement and communicatively coupled to the controller, wherein the plurality of implement actuators is configured to actuate in response to the set of implement control signals to drive the implement toward an implement pose relative to the machine frame of reference that corresponds to the grip pose as defined by the operator interface frame of reference.

17. The machine of claim 16, in which the controller is configured to:
separate the grip pose signal into a set of grip pose components, each grip pose component representing deviation of the grip from the grip neutral position to the grip pose relative to one of the grip axes;
identify a set of selected implement actuators associated with the set of grip pose components; and
communicate the set of implement control signals to the set of selected implement actuators.

18. The machine of claim 17, in which the controller is further configured to:
quantify a magnitude of deviation for each grip pose component, wherein each implement control signal is proportional to the magnitude of deviation in an associated grip axis.

19. The machine of claim 16, in which the grip is supported for movement relative to the base in the first grip linear axis, the second grip linear axis, the first grip rotational axis, the second grip rotational axis, and the third grip rotational axis, and in which the implement is supported for movement relative to the frame in the first implement linear axis, the second implement linear axis, the first implement rotational axis, the second implement rotational axis, and the third implement rotational axis.

20. The machine of claim 19, in which the first grip linear axis comprises a substantially vertical grip axis and the second grip linear axis comprises a substantially lateral grip axis.

21. The machine of claim 16, further comprising a filter operably coupled to the operator interface and configured to disable a component of the grip pose signal associated with at least one grip axis selected from a group of grip axes consisting of the first grip linear axis, the second grip linear axis, the third grip linear axes, the first grip rotational axis, the second grip rotational axis, and the third grip rotational axis.

22. The machine of claim 16, in which the grip pose includes a dominant input corresponding to a component of the grip pose having the largest deviation from a normal grip position along one of the first grip linear axis, the second grip linear axis, the third grip linear axis, the first grip rotational axis, the second grip rotational axis, and the third grip rotational axis, the implement control system further comprising a filter operably coupled to the operator interface and configured to receive the grip pose signal and provide a filtered grip pose signal including only a grip pose signal component corresponding to the dominant input of the grip pose.

23. An implement control system for a motor grader having a frame defining a machine frame of reference, the implement control system comprising:
an operator interface including:
a base defining an operator interface frame of reference, the operator interface frame of reference including a first grip linear axis, a second grip linear axis perpendicular to the first grip linear axis, a third grip linear axis perpendicular to both the first grip linear axis and the second grip linear axis, a first grip rotational axis substantially parallel to the first grip linear axis, a second grip rotational axis substantially parallel to the second grip linear axis, and a third grip rotational axis substantially parallel to the third grip linear axis;
a grip coupled to the base and configured for grasping by a hand of a user, the grip being supported for translation relative to the base in the first grip linear axis and the second grip linear axis, the grip further being rotatable about the first grip rotational axis, the second grip rotational axis, and the third grip rotational axis, wherein the grip is movable from a grip neutral position to a grip pose in which the grip deviates from the grip neutral position in at least one of the grip axes; and
a grip position sensor for detecting the grip pose configured to generate a grip pose signal;
a controller communicatively coupled to the grip position sensor for receiving the grip pose signal and generating a set of implement control signals; and
an implement assembly including:
a motor grader implement coupled to the frame and supported for movement relative to the frame in the machine frame of reference; and
a plurality of actuators operably coupled to the motor grader implement and communicatively coupled to the controller, wherein the plurality of actuators are configured to actuate in response to the set of implement control signals to drive the motor grader implement toward an implement pose relative to the machine frame of reference that corresponds to the grip pose as defined by the operator interface frame of reference.

24. The implement control system of claim 23, further comprising a filter operably coupled to the operator interface and configured to disable a component of the grip pose signal associated with at least one axis selected from a group of axes consisting of the first grip linear axis, the second grip linear axis, the first grip rotational axis, the second grip rotational axis, and the third grip rotational axis.

25. The implement control system of claim 23, in which the grip pose includes a dominant input corresponding to a component of the grip pose having the largest deviation from a normal grip position along one of the first grip linear axis, the second grip linear axis, the first grip rotational axis, the second grip rotational axis, and the third grip rotational axis, the implement control system further comprising a filter operably coupled to the operator interface and configured to receive the grip pose signal and provide a filtered grip pose signal including only a grip pose signal component corresponding to the dominant input of the grip pose.
